(19) United States
(12) Patent Application Publication
(10) Pub. No.: US 2016/0306870 A1
(43) Pub. Date: Oct. 20, 2016

(54) SYSTEM AND METHOD FOR CAPTURE, CLASSIFICATION AND DIMENSIONING OF MICRO-EXPRESSION TEMPORAL DYNAMIC DATA INTO PERSONAL EXPRESSION-RELEVANT PROFILE

(71) Applicant: ALGOSCENT, JERUSALEM (IL)

(72) Inventor: Dov YOSELIS, GEVA BNIYMIN (IL)

(73) Assignee: ALGOSCENT, JERUSALEM (IL)

(21) Appl. No.: 15/097,386

(22) Filed: Apr. 13, 2016

Related U.S. Application Data
(60) Provisional application No. 62/146,978, filed on Apr. 14, 2015.

(51) Int. Cl. G06F 17/30

(52) U.S. Cl. CPC G06F 17/30598; G06F 17/30528

(57) ABSTRACT

A system and a method for capture, classification and dimensioning of data. Particularly, a system and a method for capture, classification and dimensioning of spatiotemporal texture data associated with the micro-expression temporal dynamic features, or involuntary expressions having a very short duration, to generate a personal expression-relevant classified data profile by using a mobile device in a user-friendly and time-efficient manner responsive to user's needs.

### FIELD OF THE INVENTION

The present invention generally relates to capture, classification and dimensioning of data, more specifically to capture, classification and dimensioning of spatiotemporal texture data associated with the micro-expression temporal dynamic features to generate a personal expression-relevant classified data profile by using a mobile device.

### BACKGROUND OF THE INVENTION

Various embodiments of the present invention relate generally to personal Business Intelligence (BI) profile and more specifically to a method and system for personal BI metrics on data collected from multiple data sources that may include micro-expression temporal dynamic features data. BI refers to technologies, applications and practices for collection, integration, analysis, and presentation of content such as business information. Current BI applications collect content from various information sources such as newspapers, articles, blogs and social media websites by using tools such as web crawlers, downloaders, and RSS readers. The collected content is manipulated or transformed in order fit into predefined data schemes that have been developed to provide businesses with specific BI metrics. The content may be related to sales, production, operations, finance, etc. After collection and manipulation, the collected content is stored in a data warehouse or a data mart. The content is then transformed by applying information extraction techniques in order to provide the BI metrics to users.

Current BI applications are designed or architected to provide specific analytics and thus expect a specific data schema or arrangement. Thus, current BI applications are not able to utilize the various metadata, either explicit or inherent. Current BI applications are incapable of utilizing personal data analysis, such as one's micro-expression temporal dynamic features, and transform the collected content into a personal expression-relevant classified data profile, a digital personality profile. Facial micro-expressions are rapid involuntary facial expressions which reveal suppressed affection, e.g. a suppressed feeling. Humans are good at recognizing full facial expressions for the need of normal social interaction, e.g. facial expressions that last for at least half second, but can seldom detect the occurrence of facial micro-expressions, e.g. expressions lasting less than half a second. The micro-expressions may be defined as very rapid involuntary facial expressions which give a brief glimpse to feelings that a person undergoes but tries not to express voluntarily. Existing micro-expression analysis may be performed by computing spatio-temporal local texture descriptor (SLTD) features of the reference content, thus obtaining SLTD features that describe spatio-temporal motion parameters of the reference content. The SLTD features may be computed, for example, by using a state-of-the-art Local Binary Pattern Three Orthogonal Planes (LBP-TOP) algorithm disclosed in G. Zhao, M. Pietikäinen: “Dynamic Texture Recognition Using Local Binary Patterns with an Application to Facial Expressions”, IEEE TRANSACTIONS ON PATTERN ANALYSIS AND MACHINE INTELLIGENCE, vol. 29(6), pages 915 to 928, 2007 which is incorporated herein in its entirety as a reference. Alternatively, another algorithm arranged to detect spatio-temporal texture variations in an image sequence comprising a plurality of video frames may be used. The texture may be understood as to refer to surface patterns of the video frames. Another feature may be analysed instead of the texture, e.g. colour, shape, location, motion, edge detection, or any domain-specific descriptor. A person skilled in the art is able to select an appropriate state-of-the-art algorithm depending on the feature being analysed, and the selected algorithm may be different from LBP-TOP. For example, the video analysis system may employ a Canny edge detector algorithm for detecting edge features from individual or multiple video frames, a histogram of shape contexts detector algorithm for detecting shapes in the individual or multiple video frames, opponent colour LBP for detecting colour features in individual or multiple video frames, and/or a histogram of oriented gradients for detecting motion in the image sequence.

Therefore, there is a long felt and unmet need for a system and a method for capture, classification and dimensioning of spatiotemporal texture data associated with the micro-expression temporal dynamic features to generate a personal expression-relevant classified data profile by using a mobile device in a user-friendly and time-efficient manner responsive to user's needs.

### SUMMARY

The present invention provides a machine-implemented method for a pipelined process of capture, classification and dimensioning of data from a plurality of data sources that comprise spatiotemporal texture vectors data associated with the micro-expression temporal dynamic features to generate a personal expression-relevant classified data profile that is useable by a plurality of different intelligence metrics to perform different kinds of personal business intelligence analytics, the method comprising using a data processing machine to collect ingested data as one or more parameters from each of the plurality of data sources that comprise spatiotemporal texture vectors data associated with the micro-expression temporal dynamic features and automatically generate and store an ingested data index representing the ingested data that comprises at least a micro-expression and extracted meta data for each parameter; using a data processing machine to automatically classify each of the one or more parameters into one or more relevance classifications that are stored with the ingested data index for that parameter to form a personal expression-relevant classified data profile representing the ingested data, wherein the relevance classifications are based on a plurality of dynamically generated micro-expression features that are generated in response to machine analysis that comprises machine-defined classifiers; and using a data processing machine to automatically process the plurality of data sources and after the one or more parameters have been initially ingested and classified by utilizing the micro-expression temporal dynamic features to generate personal analytics results that are presented for a user, including processing at least one of the parameters in the ingested data with each intelligence metric module based upon a plurality of dimensions abstracted from the relevance classifications and the extracted metadata that comprises at least one implicit dimension derived from said personal expression-relevant classified data profile.

It is another object of the current invention to disclose a system for capturing, classification and dimensioning of data from a plurality of data sources that comprise spatiotemporal texture vectors data associated with the micro-expression temporal dynamic features to generate a personal expression-relevant classified data profile that is useable by a plurality of different intelligence metrics to perform different kinds of personal business intelligence analytics, said system comprising at least one processor; at least one display; and at least one memory including a computer program code and a database comprising one or more relevance classifications that are stored with an ingested data index for a predetermined parameter to form a personal expression-relevant classified data profile representing the ingested data, the relevance classifications are based on a plurality of dynamically generated micro-expression features that are generated in response to machine analysis that comprises machine-defined classifiers; the at least one memory and the computer program code are configured, with the at least one processor, to cause the system to use a data processing machine to collect ingested data as one or more parameters from each of the plurality of data sources that comprise spatiotemporal texture vectors data associated with the micro-expression temporal dynamic features and automatically generate and store an ingested data index representing the ingested data that comprises at least a micro-expression and extracted meta data for each parameter; use a data processing machine to automatically classify each of the one or more parameters into one or more relevance classifications that are stored with the ingested data index for that parameter to form a personal expression-relevant classified data profile representing the ingested data, wherein the relevance classifications are based on a plurality of dynamically generated micro-expression features that are generated in response to machine analysis that comprises machine-defined classifiers; and use a data processing machine to automatically process the plurality of data sources and after the one or more parameters have been initially ingested and classified by utilizing the micro-expression temporal dynamic features to generate personal analytics results that are presented for a user, including processing at least one of the parameters in the ingested data with each intelligence metric module based upon a plurality of dimensions abstracted from the relevance classifications and the extracted metadata that comprises at least one implicit dimension derived from said personal expression-relevant classified data profile.

### BRIEF DESCRIPTION OF THE FIGURES

In the following detailed description of the preferred embodiments, reference is made to the accompanying drawings that form a part thereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

FIG. 1 is a block diagram of a method for a pipelined process of capture, classification and dimensioning of data;

FIG. 2 schematically illustrating an environment in which various embodiments of the present invention can be practiced;

FIG. 3 schematically illustrating an exemplary setup of Personal Business Intelligence (PBI) system;

FIG. 4 is an exemplary block diagram of a method of a pipelined process of capture, classification and dimensioning of data from a video comprising predetermined behavior sessions

FIG. 5 an illustration of the embodiment of exemplary facial feature points of a model face being analyzed based on different forms of micro-expressions.

### DETAILED DESCRIPTION OF THE EMBODIMENTS

In the following detailed description of the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention. The present invention may be practiced according to the claims without some or all of these specific details. For the purpose of clarity, technical material that is known in the technical fields related to the invention has not been described in detail so that the present invention is not unnecessarily obscured.

This invention recites or refers to a machine-implemented method for a pipelined process of capture, classification and dimensioning of data from a plurality of data sources that comprise spatiotemporal texture vectors data associated with the micro-expression temporal dynamic features to generate a personal expression-relevant classified data profile that is useable by a plurality of different intelligence metrics to perform different kinds of personal business intelligence analytics, the method comprising using a data processing machine to collect ingested data as one or more parameters from each of the plurality of data sources that comprise spatiotemporal texture vectors data associated with the micro-expression temporal dynamic features and automatically generate and store an ingested data index representing the ingested data that comprises at least a micro-expression and extracted meta data for each parameter; using a data processing machine to automatically classify each of the one or more parameters into one or more relevance classifications that are stored with the ingested data index for that parameter to form a personal expression-relevant classified data profile representing the ingested data, wherein the relevance classifications are based on a plurality of dynamically generated micro-expression features that are generated in response to machine analysis that comprises machine-defined classifiers; and using a data processing machine to automatically process the plurality of data sources and after the one or more parameters have been initially ingested and classified by utilizing the micro-expression temporal dynamic features to generate personal analytics results that are presented for a user, including processing at least one of the parameters in the ingested data with each intelligence metric module based upon a plurality of dimensions abstracted from the relevance classifications and the extracted metadata that comprises at least one implicit dimension derived from said personal expression-relevant classified data profile.

The invention further recites or refers to a system for capturing, classification and dimensioning of data from a plurality of data sources that comprise spatiotemporal texture vectors data associated with the micro-expression temporal dynamic features to generate a personal expression-relevant classified data profile that is useable by a plurality of different intelligence metrics to perform different kinds of personal business intelligence analytics, said system comprising at least one processor; at least one display; and at least one memory including a computer program code and a database comprising one or more relevance classifications that are stored with an ingested data index for a predetermined parameter to form a personal expression-relevant classified data profile representing the ingested data, the relevance classifications are based on a plurality of dynamically generated micro-expression features that are generated in response to machine analysis that comprises machine-defined classifiers; the at least one memory and the computer program code are configured, with the at least one processor, to cause the system to use a data processing machine to collect ingested data as one or more parameters from each of the plurality of data sources that comprise spatiotemporal texture vectors data associated with the micro-expression temporal dynamic features and automatically generate and store an ingested data index representing the ingested data that comprises at least a micro-expression and extracted meta data for each parameter; use a data processing machine to automatically classify each of the one or more parameters into one or more relevance classifications that are stored with the ingested data index for that parameter to form a personal expression-relevant classified data profile representing the ingested data, wherein the relevance classifications are based on a plurality of dynamically generated micro-expression features that are generated in response to machine analysis that comprises machine-defined classifiers; and use a data processing machine to automatically process the plurality of data sources and after the one or more parameters have been initially ingested and classified by utilizing the micro-expression temporal dynamic features to generate personal analytics results that are presented for a user, including processing at least one of the parameters in the ingested data with each intelligence metric module based upon a plurality of dimensions abstracted from the relevance classifications and the extracted metadata that comprises at least one implicit dimension derived from said personal expression-relevant classified data profile.

The term “mobile device” interchangeably refers, but not limited to such as a mobile phone, laptop, tablet, cellular communicating device, digital camera (still and/or video), PDA, computer server, video camera, television, electronic visual dictionary, communication device, personal computer, and etc. The present invention means and methods are performed in a standalone electronic device comprising at least one screen. Additionally or alternatively, at least a portion of such as processing, memory accessible, databases, comprises a cloud-based platform, and/or web-based platform. In some embodiments, the software components and/ or image databases provided, are stored in a local memory module and/or stored in a remote server.

The term “memory”, interchangeably refers hereinafter to any memory that can be accessed and interfaced with by a machine (e.g. computer) including, but not limited to, high-speed random access memory and may also comprise non-volatile memory, such as one or more magnetic disk storage devices, flash memory devices, or other non-volatile solid-state memory devices, a direct-access data storage media such as hard disks, CD-RWs and DVD-RW can also be used to store software components and/or image/video/audio databases.

The term “display” interchangeably refers hereinafter to any touch-sensitive surface, known in the art, sensor or set of sensors that accepts input from the user based on haptic and/or tactile contact. The touch screen, along with any associated modules and/or sets of instructions in memory) detect contact, movement, detachment from contact on the touch screen and convert the detected contact into interaction with user-interface objects (e.g., one or more soft keys, icons, images, texts) that are displayed on the touch screen. In an embodiment, the user utilizes at least one finger to form a contact point detected by the touch screen. The user can navigate between the graphical outputs presented on the screen, and interact with presented digital navigation. Additionally or alternatively, the present application can be connected to a user interface detecting input from a keyboard, a button, a click wheel, a touchpad, a roller, a computer mouse, a motion detector, sound detector, speech detector, joystick, and etc., for activating or deactivating particular functions. A user can navigate among and interact with one or more graphical user interface objects that represent at least visual navigation content, displayed on screen. Preferably, the user navigates and interacts with the content/user interface objects by means of a touch screen. In some embodiments the interaction is by means such as computer mouse, motion sensor, keyboard, voice activation, joystick, electronic pad and pen, touch sensitive pad, a designated set of buttons, soft keys, and the like.

The term “storage” refers hereinafter to any collection, set, assortment, cluster, selection and/or combination of content stored digitally.

The term “macro expressions” refers hereinafter to any expressions associated with emotions such as happiness, sadness, anger, disgust, and surprise.

Embodiments of the present invention relate to configuring personal BI profile based on machine vision and, particularly, detecting automatically facial micro-expressions on a human face in an image/video analysis system. Facial micro-expressions are rapid involuntary facial expressions which reveal suppressed affection, e.g. a suppressed feeling. Humans are good at recognizing full facial expressions for the need of normal social interaction, e.g. facial expressions that last for at least half second, but can seldom detect the occurrence of facial micro-expressions, e.g. expressions lasting less than half a second. The micro-expressions may be defined as very rapid involuntary facial expressions which give a brief glimpse to feelings that a person undergoes but tries not to express voluntarily. The length of the micro-expressions may be between ⅓ and 1/25 second, but the precise length definition varies depending for example on the person. Currently only highly trained individuals are able to distinguish them but, even with proper training, the recognition accuracy is very low. There are numerous potential commercial applications for recognizing micro-expressions. Police or security personnel may use the micro-expressions to detect suspicious behavior, e.g. in the airports. Doctors can detect suppressed emotions of patients to recognize when additional reassurance is needed. Teachers can recognize unease in students and give a more careful explanation. Business negotiators can use glimpses of happiness to determine when they have proposed an acceptable price. However, an automated method for recognizing micro-expressions has yet been used to create a personal expression-relevant classified data profile to help and enhance one's evaluation of one's personality associated with used by one's content, thus an alternative and automated method for creating a personal expression-relevant classified data profile based on one's micro-expressions would be very valuable.

Some challenges in recognizing micro-expressions relate to their very short duration and involuntariness. The short duration means that only a very limited number of video frames are available for analysis with a standard 25 frame-per-second (fps) camera. Furthermore, with large variations in facial expression appearance, a machine learning approach based on training data suits the problem. Training data acquired from acted voluntary facial expressions are least challenging to gather. However, since micro-expressions are involuntary, acted micro-expressions will differ greatly from spontaneous ones. One of the extraction techniques that is applied in this invention is “motion magnification”, a technique that acts like a microscope for visual motion. The technique can amplify subtle motions in a frame sequence, allowing for visualization of deformations that would otherwise be invisible. To achieve motion magnification, it is needed to accurately measure visual motions, and group the pixels to be modified. After an initial image registration step, the motion is measured by a robust analysis of feature point trajectories, and segment pixels based on similarity of position, color, and motion. The analysis provides a measurement of motion similarity groups even very small motions according to correlation over time, which often relates to physical cause. An outlier mask marks observations not explained by our layered motion model, and those pixels are simply reproduced on the output from the original registered observations. The motion of any selected layer may be magnified by a user-specified amount; texture synthesis fills-in unseen gaps revealed by the amplified motions. The resulting motion-magnified images can reveal or emphasize small motions in the original sequence, subtle motions or balancing corrections of people, and their involuntary emotions.

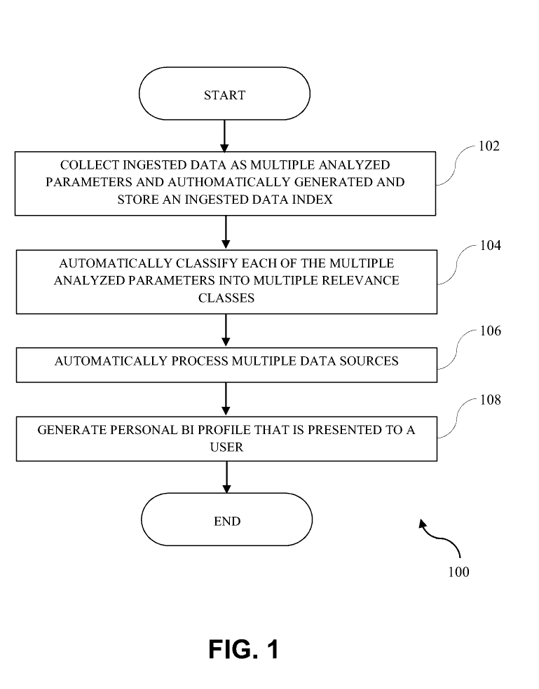

Reference is now made to FIG. 1 is a block diagram of one embodiment of a method for a pipelined process of capture, classification and dimensioning of data from a plurality of data sources that comprise spatiotemporal texture vectors data associated with the micro-expression temporal dynamic features to generate a personal expression-relevant classified data profile by using a mobile device that is useable by a plurality of different intelligence metrics to perform different kinds of personal business intelligence analytics 100, the method comprising using a data processing machine to collect ingested data as one or more parameters from each of the plurality of data sources that comprise spatiotemporal texture vectors data associated with the micro-expression temporal dynamic features and automatically generate and store an ingested data index representing the ingested data that comprises at least a micro-expression and extracted meta data for each parameter 102; using a data processing machine to automatically classify each of the one or more parameters into one or more relevance classifications that are stored with the ingested data index for that parameter to form a personal expression-relevant classified data profile representing the ingested data, wherein the relevance classifications are based on a plurality of dynamically generated micro-expression features that are generated in response to machine analysis that comprises machine-defined classifiers 104; and using a data processing machine to automatically process the plurality of data sources and after the one or more parameters have been initially ingested and classified by utilizing the micro-expression temporal dynamic features 106 to generate personal analytics results that are presented for a user, including processing at least one of the parameters in the ingested data with each intelligence metric module based upon a plurality of dimensions abstracted from the relevance classifications and the extracted metadata that comprises at least one implicit dimension derived from said personal expression-relevant classified data profile 108. The parameter classification may comprise an indicator indicating the presence of a micro-expression temporal dynamic feature in the reference content and/or at least one of the following micro-expression types associating the micro-expression to a feeling of the person in the reference content: affection, anger, angst, anguish, annoyance, anxiety, apathy, arousal, awe, boldness, boredom, contempt, contentment, curiosity, depression, desire, despair, disappointment, disgust, dread, ecstasy, embarrassment, envy, euphoria, excitement, fear, fearlessness, frustration, gratitude, grief, guilt, happiness, hatred, hope, horror, hostility, hurt, hysteria, indifference, interest, jealousy, joy, loathing, loneliness, love, lust, misery, nervousness, panic, passion, pity, pleasure, pride, rage, regret, remorse, sadness, satisfaction, shame, shock, shyness, sorrow, suffering, surprise, terror, uneasiness, wonder, worry, zeal, zest.

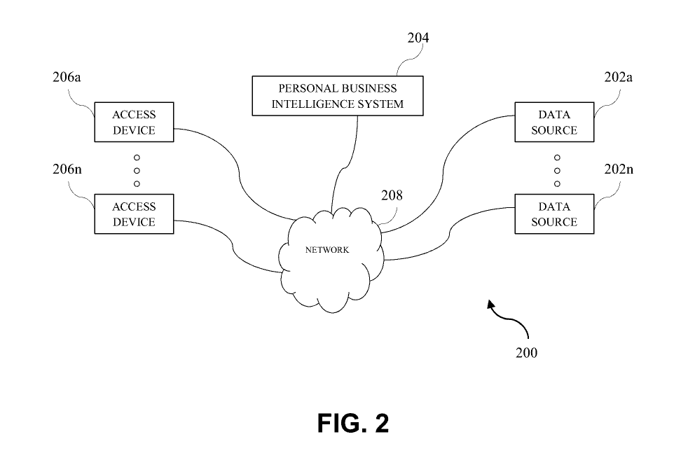

Reference is now made to FIG. 2 schematically illustrating an environment 200 in which various embodiments of the present invention can be practiced. Environment 200 includes a plurality of data sources 202-a to 202-n (hereinafter referred as data sources 202), a Business Intelligence (BI) system 204, one or more access devices 206-a to 206-n (hereinafter referred as access devices 206), and a network 208. Data sources 202 are sources of spatiotemporal texture vectors data associated with the micro-expression temporal dynamic features. Examples of data sources 202 include, but are not limited to eye-tracking, facial recognition, facial motion, gestures, voice change or any combination thereof. In one embodiment, data sources 202 are provided to a user through a user interface, from which the user selects the appropriate data sources 202 for extracting pertinent data. Personal Business Intelligence (PBI) system 204 is a computational system that aggregates or ingests the pertinent data from data sources 202, and performs various information extracting techniques, such as eye-tracking extraction, facial recognition extraction, facial motion extraction, gestures extraction, voice change extraction or any combination thereof. Once, the information extracting techniques are applied, PBI system 204 executes analytics, such as personality analysis, emotion analysis, and stores the resulting PBI metrics, making the results available to the user through various interfaces, or available to subsequent applications as input. In various embodiments PBI Metrics are used to assess the impact of the collected data and is used for better emotional self-evaluation. Access devices 206 are digital devices that include a Graphical User Interface (GUI) and are capable of communicating with the PBI system 204 over a network 208. Examples of access devices 206 include mobile phones, laptops, Personal Digital Assistants (PDAs), pagers, Programmable Logic Controllers (PLCs), wired phone devices, and the like. Examples of network 208 include, but are not limited to, Local Area Network (LAN), Wide Area Network (WAN), satellite network, wireless network, wired network, mobile network, and other similar networks. Access devices 206 are operated by users to communicate with PBI system 204. In various embodiments, dashboards and reports may be automatically generated to display the result of the PBI metrics on a screen of access devices 206. Access devices 206 communicate with PBI system 204 through a client application such as a web browser, a desktop application configured to communicate with PBI system 204, and the like.

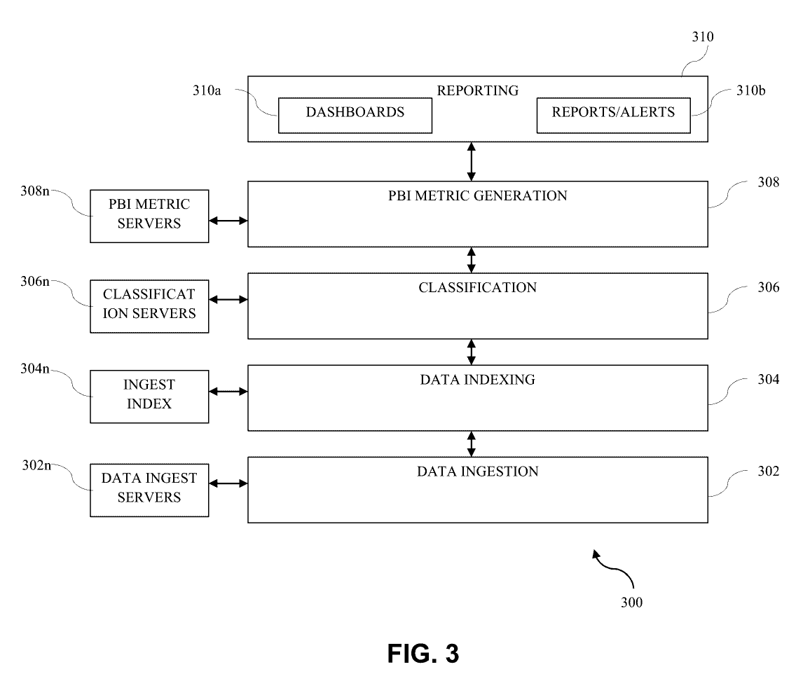

Reference is now made to FIG. 3, illustrating an exemplary setup of PBI system 300, in accordance with various embodiment of the present invention. PBI system 300 may include a machine-implemented pipelined process including a data ingestion (or aggregation) 302 module, a data indexing (or dimensioning) 304 module, a classification 306 module, a business intelligence metric generation 308 module, and a reporting 310 module. In various embodiments, the data ingestion 302 module is performed utilizing numerous internal 302a and external 302b data sources using one or more data ingestion tools such as eye-tracking, facial recognition, facial motion, gestures, voice change, and others. For purpose of the present invention, it will be understood that ingested data is meant to include data ingested from internal 302a and external 302b sources. In this way, the system and method are able to ingest data from a variety of sources and in a variety of forms without costly, error-prone and time-consuming data transformations. In various embodiments, for image, audio and video data, the data index is based on presence of specified features or data such as presence or detection or movement of specific objects. These features or data may be extracted utilizing various video, audio and image information extraction techniques based on existing or established video, audio and image feature recognition and detection tools.

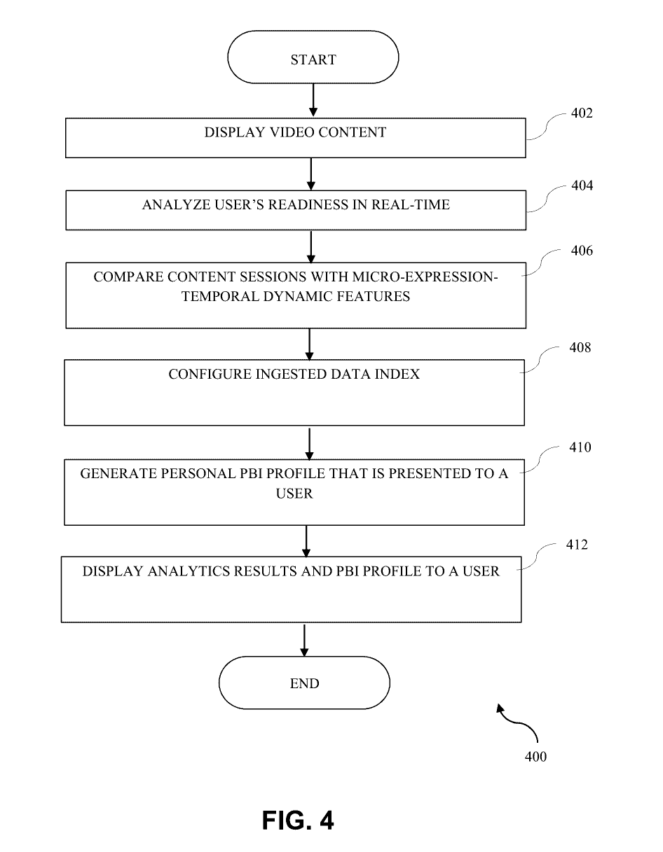

Reference is now made to FIG. 4, illustrating an exemplary block diagram of one embodiment of a method of a pipelined process of capture, classification and dimensioning of data from a video comprising predetermined behavior sessions 400. According to one embodiment of the invention the method 400 comprising using a data processing machine to collect ingested data in a form of video content 402; using a mobile device camera to analyze user's readiness in real time 404; using a data processing machine to automatically process the displayed content and after the one or more parameters have been initially ingested and classified by utilizing the micro-expression temporal dynamic features to compare said features to video content sessions 406; generate and store an ingested data index representing the ingested data that comprises at least a micro-expression and extracted meta data for each parameter 408; generate personal analytics results that are presented for a user 410, including processing at least one of the parameters in the ingested data with each intelligence metric module based upon a plurality of dimensions abstracted from the relevance classifications and the extracted metadata that comprises at least one implicit dimension derived from said personal expression-relevant classified data profile; generate analytics results that are presented for a user further configured to provide a display user interface accessible using the data processing machine 412.

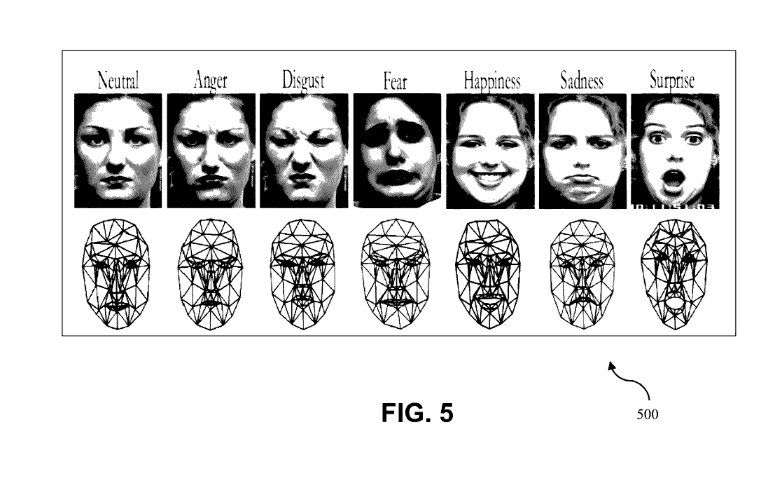

Reference is now made to FIG. 5, illustrating an exemplary facial feature points of a model face being analyzed based on different forms of micro-expressions 500.

What is claimed is:

1. A machine-implemented method for a pipelined process of capture, classification and dimensioning of data from a plurality of data sources that comprise spatiotemporal texture vectors data associated with the micro-expression temporal dynamic features to generate a personal expression-relevant classified data profile by using a mobile device that is useable by a plurality of different intelligence metrics to perform different kinds of personal business intelligence analytics, the method comprising:
a. using a data processing machine to collect ingested data as one or more parameters from each of the plurality of data sources that comprise spatiotemporal texture vectors data associated with the micro-expression temporal dynamic features and automatically generate and store an ingested data index representing the ingested data that comprises at least a micro-expression and extracted meta data for each parameter;
b. using a data processing machine to automatically classify each of the one or more parameters into one or more relevance classifications that are stored with the ingested data index for that parameter to form a personal expression-relevant classified data profile representing the ingested data, wherein the relevance classifications are based on a plurality of dynamically generated micro-expression features that are generated in response to machine analysis that comprises machine-defined classifiers; and
c. using a data processing machine to automatically process the plurality of data sources and after the one or more parameters have been initially ingested and classified by utilizing the micro-expression temporal dynamic features to generate personal analytics results that are presented for a user, including processing at least one of the parameters in the ingested data with each intelligence metric module based upon a plurality of dimensions abstracted from the relevance classifications and the extracted metadata that comprises at least one implicit dimension derived from said personal expression-relevant classified data profile,
wherein the intelligence metric modules are integrated with the ingested data, and the micro-expression temporal dynamic features upon which the relevance classifications are based are determined prior to using the data processing machine to collect ingested data.

2. The machine-implemented method of claim 1 further comprising collecting ingested data as one or more parameters from each of the plurality of data sources that comprise spatiotemporal texture vectors data associated with the micro-expression temporal dynamic features by spotting both macro expressions and rapid micro-expressions.

3. The machine-implemented method of claim 2, wherein rapid micro-expressions associated with semi-suppressed macro-expressions.

4. The machine-implemented method of claim 1 further comprising:
a. obtaining user-feedback from the user in response to the analytic results that are presented for the user; and
b. causing a data processing machine to adaptively utilize the user-feedback to modify the relevance classifications.

5. The machine-implemented method of claim 1 wherein the plurality of micro-expression data sources comprises user's extracted images, video and audio.

6. The machine-implemented method of claim 1 wherein using a data processing machine to collect ingested data comprises collecting data from the plurality of data sources that comprise user's extracted images, video and audio content.

7. The machine-implemented method of claim 1 using a data processing machine to collect ingested data further comprises using automated information extraction techniques to generate at least some of the extracted meta data for each parameter, wherein different automated information extraction techniques are used for different types of parameters.

8. The machine-implemented method of claim 7 wherein the different automated information extraction techniques used for different types of parameters comprise a group of analyzed features comprising eye-tracking extraction, facial recognition extraction, facial motion extraction, gestures extraction, voice change extraction, motion magnification analysis, synthetic shutter time analysis, video textures analysis, layered motion analysis and any combinations thereof.

9. The machine-implemented method of claim 1, wherein using a data processing machine to automatically process the ingested data with the plurality of different intelligence metric modules comprises reprocessing the one or more parameters with at least one of the intelligence metric modules.

10. The machine-implemented method of claim 4, wherein using a data processing machine to automatically process the ingested data with the plurality of different intelligence metric modules to generate analytics results that are presented for a user comprises providing a display user interface accessible using the data processing machine.

11. A system for capturing, classification and dimensioning of data from a plurality of data sources that comprise spatiotemporal texture vectors data associated with the micro-expression temporal dynamic features to generate a personal expression-relevant classified data profile by using a mobile device that is useable by a plurality of different intelligence metrics to perform different kinds of personal business intelligence analytics, said system comprising:
a. at least one processor;
b. at least one display; and
c. at least one memory including a computer program code and a database comprising one or more relevance classifications that are stored with an ingested data index for a predetermined parameter to form a personal expression-relevant classified data profile representing the ingested data, wherein the relevance classifications are based on a plurality of dynamically generated micro-expression features that are generated in response to machine analysis that comprises machine-defined classifiers;
wherein the at least one memory and the computer program code are configured, with the at least one processor, to cause the system to:
a. use a data processing machine to collect ingested data as one or more parameters from each of the plurality of data sources that comprise spatiotemporal texture vectors data associated with the micro-expression temporal dynamic features and automatically generate and store an ingested data index representing the ingested data that comprises at least a micro-expression and extracted meta data for each parameter;
d. use a data processing machine to automatically classify each of the one or more parameters into one or more relevance classifications that are stored with the ingested data index for that parameter to form a personal expression-relevant classified data profile representing the ingested data, wherein the relevance classifications are based on a plurality of dynamically generated micro-expression features that are generated in response to machine analysis that comprises machine-defined classifiers; and
e. use a data processing machine to automatically process the plurality of data sources and after the one or more parameters have been initially ingested and classified by utilizing the micro-expression temporal dynamic features to generate personal analytics results that are presented for a user, including processing at least one of the parameters in the ingested data with each intelligence metric module based upon a plurality of dimensions abstracted from the relevance classifications and the extracted metadata that comprises at least one implicit dimension derived from said personal expression-relevant classified data profile.

12. The system of claim 11, wherein the at least one memory and the computer program code are configured, with the at least one processor, to cause the system to collect ingested data as one or more parameters from each of the plurality of data sources that comprise spatiotemporal texture vectors data associated with the micro-expression temporal dynamic features by spotting both macro expressions and rapid micro-expressions.

13. The system of claim 12, wherein rapid micro-expressions associated with semi-suppressed macro-expressions.

14. The system of claim 11, wherein the at least one memory and the computer program code are configured, with the at least one processor, to cause the system to:
a. obtain user-feedback from the user in response to the analytic results that are presented for the user; and
b. cause a data processing machine to adaptively utilize the user-feedback to modify the relevance classifications.

15. The system of claim 11, wherein the plurality of micro-expression data sources comprises user's extracted images, video and audio.

16. The system of claim 11, wherein the at least one memory and the computer program code are configured, with the at least one processor, to cause the system to use a data processing machine to collect ingested data further configured to collect data from the plurality of data sources that comprise user's extracted images, video and audio content.

17. The system of claim 11, wherein the at least one memory and the computer program code are configured, with the at least one processor, to cause the system to use a data processing machine to collect ingested data further configured to use automated information extraction techniques to generate at least some of the extracted meta data for each parameter, wherein different automated information extraction techniques are used for different types of parameters.

18. The system of claim 17, wherein the different automated information extraction techniques used for different types of parameters comprise a group of analyzed features comprising eye-tracking extraction, facial recognition extraction, facial motion extraction, gestures extraction, voice change extraction, magnification analysis, synthetic shutter time analysis, video textures analysis, layered motion analysis and any combinations thereof.

19. The system of claim 11, wherein the at least one memory and the computer program code are configured, with the at least one processor, to cause the system to use a data processing machine to automatically process the ingested data with the plurality of different intelligence metric modules further configured to reprocess the one or more parameters with at least one of the intelligence metric modules.

20. The system of claim 14, wherein the at least one memory and the computer program code are configured, with the at least one processor, to cause the system to automatically process the ingested data with the plurality of different intelligence metric modules to generate analytics results that are presented for a user further configured to provide a display user interface accessible using the data processing machine.
